(19) United States
(12) Patent Application Publication
(10) Pub. No.: US 2025/0349465 A1
(43) Pub. Date: Nov. 13, 2025

(54) Electrostatic Structures

(71) Applicant: Jeffrey DeGroof, Orlando, FL (US)

(72) Inventor: Jeffrey DeGroof, Orlando, FL (US)

(21) Appl. No.: 18/661,583

(22) Filed: May 11, 2024

(51) Int. Cl. H01G 2/10; B63B 25/00

(52) U.S. Cl. CPC H01G 2/106; B63B 25/002

(57) ABSTRACT

A structure is supported by electrostatic forces produced by a shell of one or more capacitors wherein an inner plate, or plates, of like charge define and support an interior volume. When charged, the repelling force of the interior plate(s) are capable of supporting the interior volume under greater pressures than could be withstood otherwise.

### BACKGROUND OF THE INVENTION

Ability to form lightweight and sturdy constructions have been a widely sought material property for many applications. The principal example at present is the vacuum balloon. A vacuum balloon must be incredibly lightweight while retaining volume under significant pressure. The predominant methodology in the pursuit of this class of construction is the use of material science to formulate new materials with the desired physical properties. However, such substances often prove difficult to manufacture particularly in the large amounts and structures needed for many of the designs that attempt to utilize them. Therefore, a method of creating structures with a particular strength largely independent of material is desirable. In order to do so, the structure must utilize a force capable of being manipulated in strength without changing the material.

### SUMMARY OF THE INVENTION

A structure comprised of a shell of one or more capacitors wherein an inner plate, or plates, of like charge define an interior volume. When charged, the repelling force of the interior plate(s) are capable of supporting the interior volume under greater pressures than could be withstood otherwise. This interior volume may be, but is not limited to, a filled volume, a cavity, or a container.

### BRIEF DESCRIPTION OF DRAWINGS

FIG. 1 is a front partially cutaway view illustrating a spherical structure, according to an embodiment of the present invention.

FIG. 2 is an oblique cutaway view illustrating a cylindrical structure, according to an embodiment of the present invention.

FIG. 3 is a side view illustrating a pill-shaped structure, according to an embodiment of the present invention.

### DETAILED DESCRIPTION OF THE INVENTION

In the present disclosure, many specific details and examples are described, to provide a thorough understanding of embodiments of the invention. Persons with ordinary skill in the field will understand the invention can be used without one or more of these specific details. The well-known details are not described in detail for simplicity.

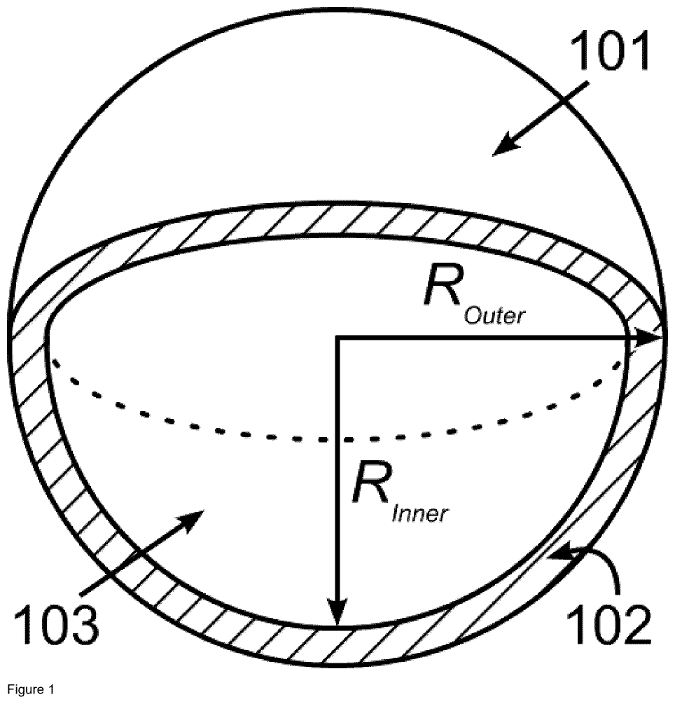

In one exemplary embodiment of this structure, the capacitor shell in FIG. 1 is a concentric spherical capacitor where the inner spherical plate 103 of radius R_{Inner} is close in size to the outer plate 101 of radius R_{Outer} with a dielectric separating the two 102. Since this embodiment exhibits spherical symmetry, Gauss's Law can be used to explain how it works.

A spherical Gaussian surface enclosing the whole structure contains both plates and thus both the positive and negative charge (Q). These charges cancel each other out and thus there is no electric field outside the structure.

On the outer sphere 101, both charges are still enclosed and thus there is no electric field. This means that the outer sphere does not feel any pressure from the electric forces in the capacitor.

In between the spheres, a Gaussian surface only encloses the charge of the inner sphere. Here there is an electric field that the dielectric 102 must be strong enough to resist.

On the inner sphere 103, the interior charge is enclosed. Thus the inner sphere produces an electrostatic pressure which, when greater than or equal to the external pressure, is capable of sustaining a lower pressure in the interior volume.

Within the interior volume of the inner sphere, there is no enclosed charge and thus no electric field, so there is no concern of ionizing the interior volume.

The charge on the inner sphere is what determines the strength of the electrostatic pressure for a given radius Rᵢₙₙₑᵣ of the inner sphere. As a capacitor, the charge is determined by its capacitance and voltage.

The capacitance of the capacitor in FIG. 1 can be increased either by using a dielectric with a higher relative permittivity or reducing the difference between Rᵢₙₙₑᵣ and Rₒᵤₜₑᵣ. In FIG. 1 the difference between Rᵢₙₙₑᵣ and Rₒᵤₜₑᵣ is larger for the purposes of illustration. In more practical embodiments, the difference would be as small as is practical in order to reduce the weight of the dielectric and increase capacitance and thus decrease the necessary voltage for a given charge.

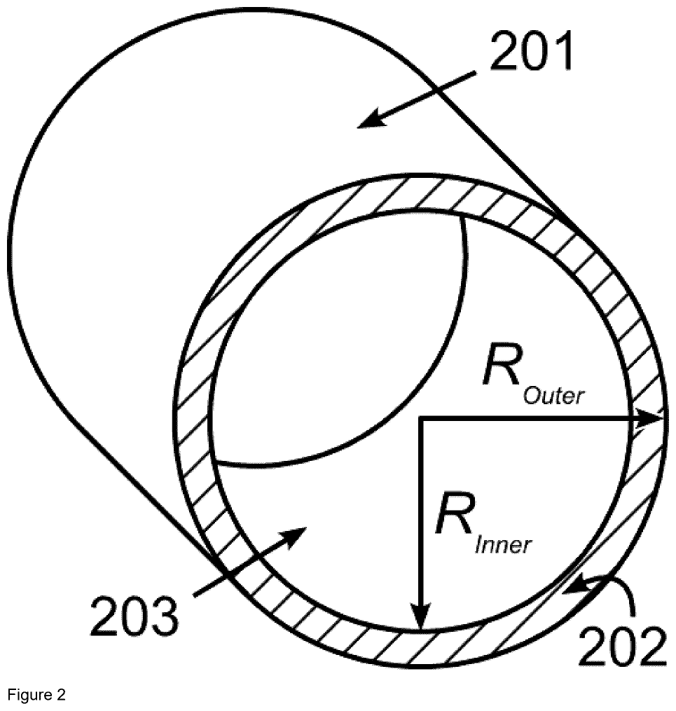

In another embodiment, the capacitor shell in FIG. 2 is a coaxial cylindrical capacitor where the inner cylindrical plate 203 of radius Rᵢₙₙₑᵣ is close in size to the outer plate 201 of radius R_{Outer} with a dielectric separating the two 202. This embodiment functions similarly to the spherical case, but with cylindrical symmetry instead of spherical. However, a purely cylindrical design does not account for pressure on the ends of the cylinder which may cause this embodiment to fail.

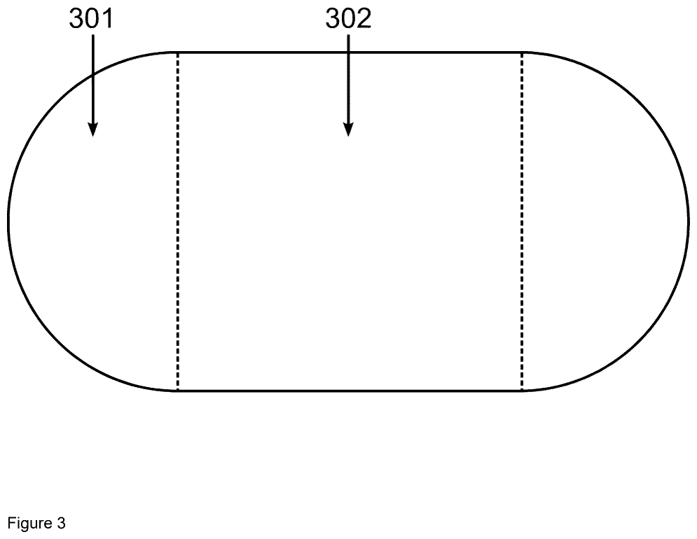

In another embodiment, the capacitor shell in FIG. 3 is pill shaped. This design combines a section of a cylindrical embodiment 301 and separated hemispherical sections of a spherical embodiment 302. This accounts for pressure on the ends of a cylindrical embodiment, but this support weakens as the cylinder grows longer. As this design exhibits non-ideal symmetry, it is subject to uneven forces towards either end of the cylindrical section. These forces may be counteracted by structural reinforcement and brings into consideration the strengths of the materials used.

In embodiments under pressure equilibrium, the structural properties of the materials, such as compressive or tensile strength, are largely unimportant for the purposes of generating the necessary electrostatic pressure as the pressure is even and should not induce stresses in the material. These strengths are important, however, when the structure encounters external forces, such as impacts or extrinsic pressures, and determines its integrity in those circumstances.

In some embodiments, the inner and outer plates may be constructed out of metal foils, such as tin or aluminum foil, and made as thinly as is practical for the purpose of saving weight.

In some embodiments, the dielectric between the plates may be constructed out of plastics such as polytetrafluoroethylene (PTFE) or biaxially oriented polyethylene terephthalate (BoPET) to more easily construct thin insulative layers for weight savings and increasing capacitance. BoPET can be readily bonded to thin conductive layers through metalization which may be used to construct thin inner and outer plates.

In some embodiments, the interior volume is filled. These embodiments may be used to reinforce the compressive strength of their volume such as for structural reinforcement of a material they are embedded within.

In some embodiments, the interior volume is a container used to hold some other object. These embodiments may be used to impede transfer of compressive loads to the volume such as for use as packing material.

In some embodiments, the interior volume is a cavity. These embodiments may be substantially lighter than those with filled interior volumes. The cavity may contain gas, such as the surrounding atmosphere, at a low pressure which can provide buoyancy.

In embodiments where the weight of the structure is greater than the buoyant force produced by the cavity, the structure is inflated, but not buoyant. This may be used similarly to air-inflated cavities in applications such as closed-cell foams, inflatable furniture, and inflatable toys.

In embodiments where the weight of the structure is less than the buoyant force produced by the cavity, the structure is buoyant. This may be used similarly to helium or hydrogen inflated cavities in air-buoyant structures such as dirigibles.

In some embodiments, the charge on the capacitors of the structure may be varied in turn varying the generated pressure of the structure. This allows the structure to respond to increased external pressures or forces. In addition, embodiments using elastic materials may vary in size in this way. Furthermore, buoyant elastic embodiments may vary buoyancy using this variation in size.

1. A structure comprising:
a shell comprising one or more capacitors; and
an interior volume, defined and supported by inner like-charged plates of the capacitor(s), that is under reduced pressure conditions as compared to pressures on the exterior of the structure.

2. The structure of claim 1, wherein the capacitor shell is a concentric spherical capacitor.

3. The structure of claim 1, wherein the capacitor shell is a coaxial cylindrical capacitor.

4. The structure of claim 1, wherein the capacitor shell is a pill-shaped capacitor.

5. The structure of claim 1, wherein the interior volume is filled.

6. The structure of claim 1, wherein the interior volume is a container.

7. The structure of claim 1, wherein the interior volume is a cavity.

8. The structure of claim 4, wherein the cavity produces buoyancy greater than the weight of the structure.
